(19) United States
(12) Patent Application Publication
(10) Pub. No.: US 2010/0124954 A1
(43) Pub. Date: May 20, 2010

(54) SLIDE STRUCTURE

(76) Inventor: CHIN-FU HORNG, TAIPEI HSIEN (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/344,331

(22) Filed: Dec. 26, 2008

(30) Foreign Application Priority Data
Nov. 14, 2008 (TW) 097220393

(51) Int. Cl. H04M 1/00

(52) U.S. Cl. 455/575.4

(57) ABSTRACT

A slide structure is implemented in electronic device such as mobile phone. The second component is moveably connected with the first component and is moved with respect to the first component. The spring includes two ends and is positioned within a clearance. One end is fixed to the first component, and the other end is fixed to the second component. The spring extends from one end along a first direction so that a first portion is formed. Then, the spring extends along a second direction to the other end so that a second portion which is opposite to the first direction is formed. When the first component is moved to a first position, the first portion and the second portion are compressed to establish a resilient force. Then, the first portion and the second portion are extended by the resilient force so that the first component is moved to a second position.

This application claims the benefit of Taiwan Patent Application Serial NO. 097220393 filed on Nov. 14, 2008, the subject matter of which is incorporated herein by reference.

### BACKGROUND OF THE INVENTION

(1) Field of the Invention

The invention relates to a slide structure, and more in particular to a slide structure which is implemented in slide electronic device.

(2) Description of the Prior Art

Speaking of development of electronic devices, human-machine interface is getting more and more important. Electronic devices can be cellular phones, notebook computers, handheld game consoles, personal digital assistants (PDA). To increase operating area for implementing human-machine interface, slide or clamshell electronic devices are developed. Slide electronic devices usually have quality look, but mechanism of the slide electronic devices are usually much more complicated.

Recently, quite a few mobile phones are equipped with “slide” structures. In the beginning of slide mobile phones, users need to use thumbs to manipulate the slide mobile phones so it is not comfortable for users to manipulate the slide mobile phones. Then, a better active slide structure is provided at the end of sliding stoke, and that is, slide portion of the mobile phone will be resiliently biased when the slide portion is pushed to the end of slide stroke. Thus, manipulation of the slide mobile phones will be improved.

To improve manipulation of the slide mobile phones, slide-typed or liked structure is developed. Referring to FIG. 1, it illustrates a perspective view of a slide structure 2 of the prior art. Two metallic components 4 and 6 are respectively moved back and forth because of resilient members 8 so that it is comfortable for users to manipulate the slide mobile phone. As shown in FIG. 1, because the two metallic components 4 and 6 are respectively moved back and forth, interference between the resilient members 8 happens. Due to limited receiving space, how to implement the resilient members 8 to this receiving space is troublesome. Even worse, the kind of resilient members only rotate along one direction (either clockwise or counterclockwise) so when the resilient members rotate along the opposite direction, the resilient members are prone to have plastic deformation.

Referring to FIG. 2, it illustrates a perspective view of a slide structure 2a of the prior art. Similarly, two metallic components 4a and 6a are respectively moved back and forth because of several overlapped resilient members 8a. It is much more comfortable for users to manipulate the slide mobile phone because the resilient members 8a have stronger structure and higher resilience. Besides, gradient magnitude of resilience is not large so it is ideal and comfortable for users to manipulate the slide mobile phone. However, several overlapped resilient members 8a are thicker and have shorter slide stroke, so it is disadvantageous for compact and light-weighted design.

Referring to FIG. 3, it illustrates a perspective view of a slide structure 2b of the prior art. To increase slide stroke of elastic deformation, two metallic components 4b and 6b are respectively moved back and forth because of resilient member. The resilient member is two symmetrical wave sinus springs 8b. It seems to have longer slide stroke, but when two metallic components 4b and 6b are respectively moved back and forth, part of the wave sinus springs 8b concave downwardly extends. Resilience of compressive side of the wave sinus springs 8b is better, and other part of the wave sinus springs 8b concave upwards extends so resilience is not good and the wave sinus springs 8b is also prone to have plastic deformation.

Therefore, the present invention provides a slide structure which is implemented in two moveably connected components of electronic device to improve above disadvantages.

### SUMMARY OF THE INVENTION

Accordingly, it is an object of the present invention to provide a slide structure which is implemented in electronic device. Two components of the electronic device are moveably connected so that it is comfortable for users to manipulate the electronic device. Besides, the electronic device has ideal resilience, longer slide stroke and a more durable linear spring.

The present invention relates to a slide structure which is implemented in electronic device. The slide structure includes a first slide component, a second slide component, and a linear spring.

The second slide component is moveably connected with the first slide component so that the second slide component is moved with respect to the first slide component.

The linear spring includes two ends and is positioned within a clearance which is defined between the first slide component and the second slide component. One end is fixed to the first slide component, and the other end is fixed to the second slide component. The linear spring extends from one of the ends along a first turning direction so that a first spring portion is formed. Then, the linear spring extends from the first spring portion along a second turning direction to the other end so that a second spring portion is formed. The first turning direction is opposite to the second turning direction.

When the first slide component is moved to a first position with respect to the second slide component, both the first spring portion and the second spring portion are compressed and deformed so as to establish a resilient force. Then, both the first spring portion and the second spring portion will be extended and deformed by the resilient force so that the first slide component is moved to a second position with respect to the second slide component. The first position is the midpoint of the slide stroke, and both ends of the slide stroke are called the second position.

Therefore, the present invention provides a slide structure which is implemented in electronic devices such as mobile phones. Components of the electronic devices are moveably connected and biased by linear spring with two opposite spring arcs so that it is comfortable for users to manipulate the electronic device, and ideal resilient force and longer slide stroke are obtained. Furthermore, the linear spring of the present invention is more durable.

### BRIEF DESCRIPTION OF THE DRAWINGS

The present invention will now be specified with reference to its preferred embodiment illustrated in the drawings, in which:

FIG. 1 is a perspective view of a first slide structure of the prior art;

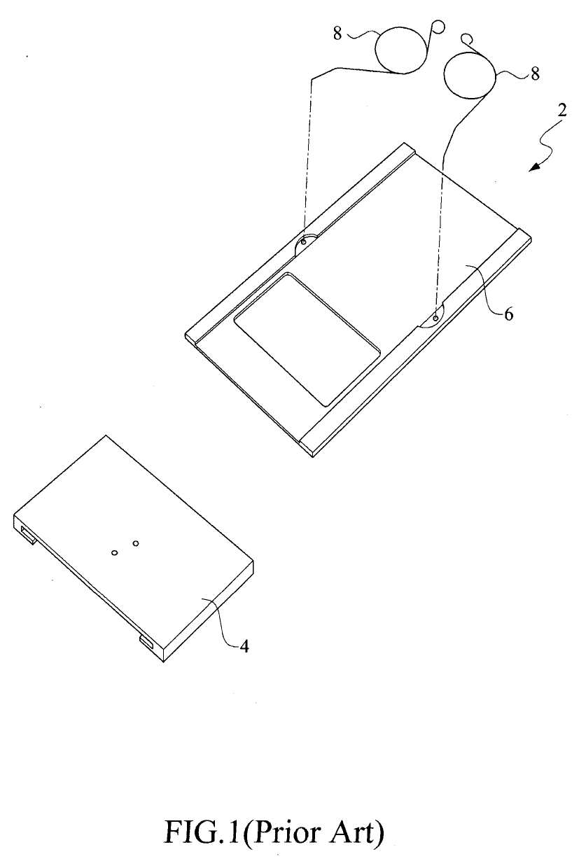

FIG. 2 is a perspective view of a second slide structure of the prior art;

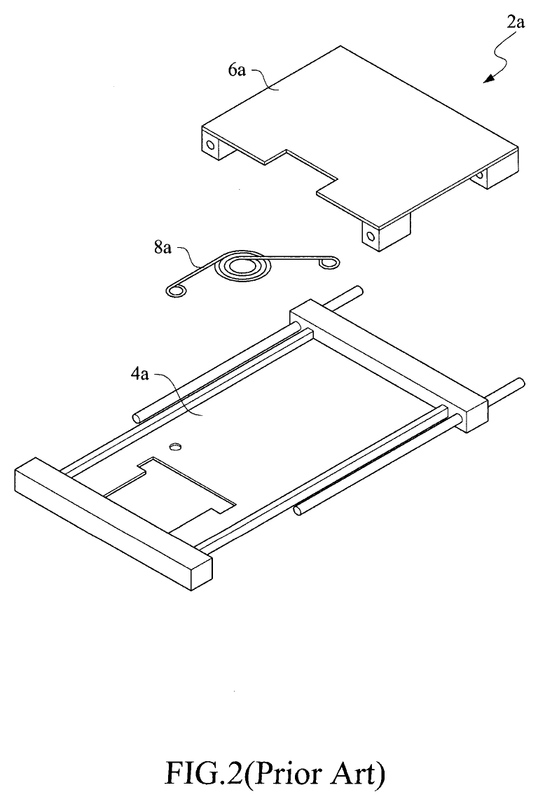

FIG. 3 is a perspective view of a third slide structure of the prior art;

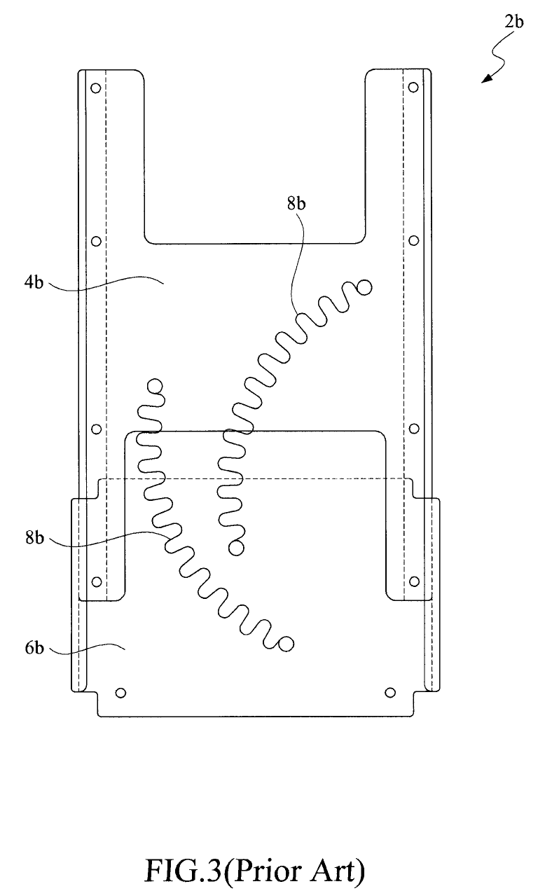

FIG. 4 is a perspective view of a slide mobile phone with a slide structure of the present invention;

FIG. 5 is a perspective view of the slide structure of FIG. 4 which is moved to one of the second positions according to the present invention;

FIG. 6 is a perspective view of a first embodiment of a linear spring which is implemented in the slide structure according to the present invention;

FIG. 7 is a perspective view of the slide structure of FIG. 4 which is moved to a first position according to the present invention;

FIG. 8 is a perspective view of the slide structure of FIG. 4 which is moved to the other one of the second position according to the present invention;

FIG. 9 is a cross-section view of a slide structure according to the present invention;

FIG. 10 is a perspective view of a second embodiment of a linear spring which is implemented in the slide structure according to the present invention;

FIG. 11 is a perspective view of a third embodiment of a linear spring which is implemented in the slide structure according to the present invention;

FIG. 12 is a perspective view of a fourth embodiment of a linear spring which is implemented in the slide structure according to the present invention; and

FIG. 13 is a perspective view of a fifth embodiment of a linear spring which is implemented in the slide structure according to the present invention.

### DESCRIPTION OF THE PREFERRED EMBODIMENT

In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

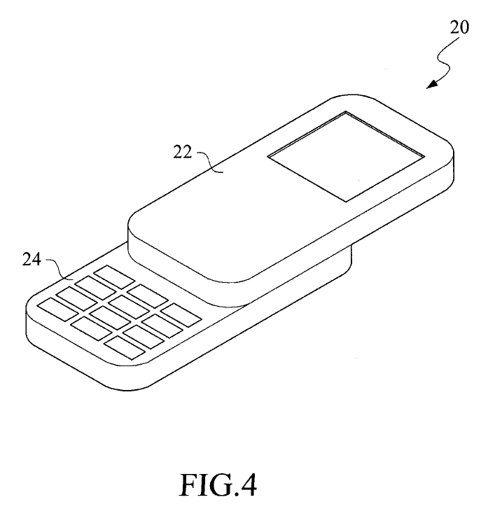

Referring to FIG. 4, it illustrates a perspective view of a slide mobile phone 20 with a slide structure of the present invention. The present invention relates a slide structure which is implemented in the slide electronic device such as mobile phone, notebook computer, handheld game console, personal digital assistant etc. As shown in FIG. 4, the mobile phone 20 includes an upper housing 22 and a lower housing 24. The upper housing 22 is movably coupled with the lower housing 24 by the slide structure. Then upper housing 22 is moved with respect to the lower housing 24.

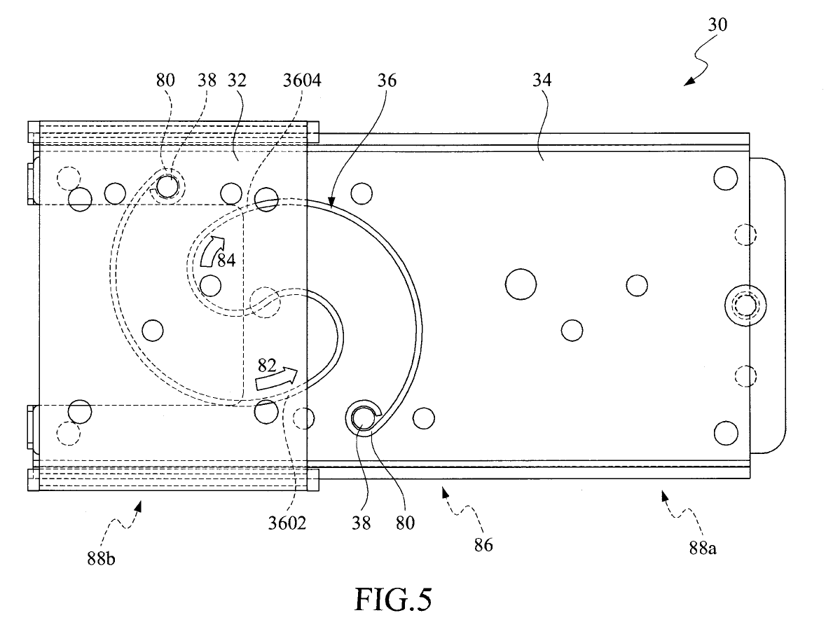

Referring FIG. 5, it illustrates a perspective view of the slide structure 30 which is moved to the second position 88a according to the present invention. The slide structure 30 includes a first slide component 32, a second slide component 34, and a linear spring 36.

The first slide component 32 is fixedly coupled with the upper housing 22, and the second slide component 34 is fixedly coupled with the lower housing 24. The second slide component 34 is movably connected with the first slide component 32 so that the first slide component 32 is moved with respect to the second slide component 34. The upper housing 22 is moved with respect to the lower housing 24 accordingly.

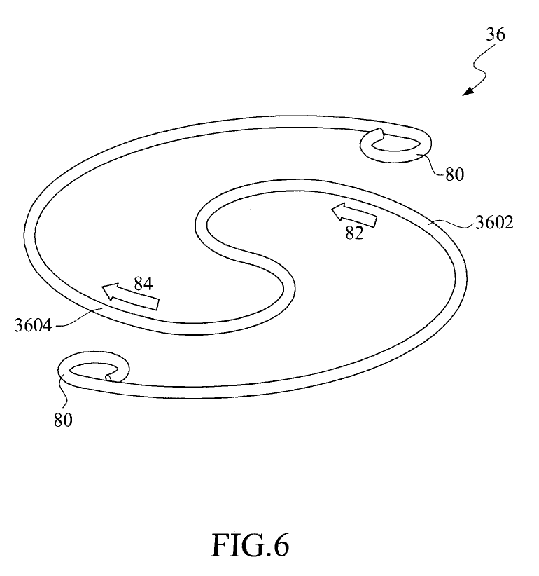

Referring to FIGS. 5 and 6, FIG. 6 illustrates a perspective view of a first embodiment of a linear spring 36 according to the present invention. The linear spring 36 includes two ends 80, and one of the ends 80 is fixed to the first slide component 32 and the other of the ends 80 is fixed to the second slide component 34. As shown in FIG. 6, the first slide component 32 and the second slide component 34 of the slide structure 30 have a rivet 38 respectively. The two ends 80 of the linear spring 36 are respectively interwined at two rivets 38 so that two ends 80 of the linear spring 36 are respectively fixed to the first slide component 32 and the second slide component 34.

The linear spring 36 extends from one of the ends 80 along a first turning direction 82 so that a first spring portion 3602 is formed. Then, the linear spring 36 extends from the first spring portion 3602 along a second turning direction 84 to the other of the ends 80 so that a second spring portion 3604 is formed. The first turning direction 82 is opposite to the second turning direction 84. As shown in FIG. 6, both the first spring portion 3602 and the second spring portion 3604 are arc-shaped so that a symbol for Taiji is formed.

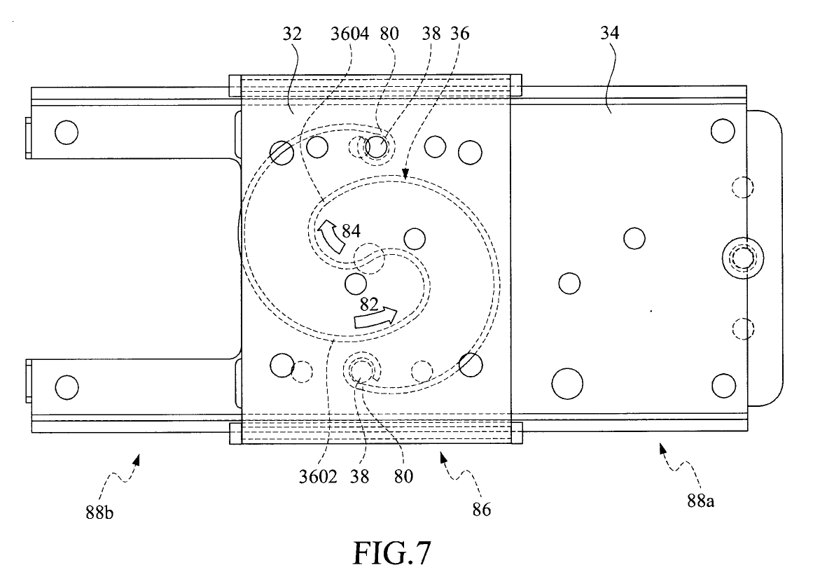

Referring to FIG. 7, it illustrates a perspective view of the slide structure 30 of FIG. 4 which is moved to a first position 86 according to the present invention. When the upper housing 22 is moved by external force, the first slide component 32 is moved to the first position 86 with respect to the second slide component 34. Then, both the first spring portion 3602 and the second spring portion 3604 are compressed and deformed so as to establish a resilient force. The first position 86 is the midpoint of the slide stroke in which the first slide component 32 is moved with respect to the second slide component 34.

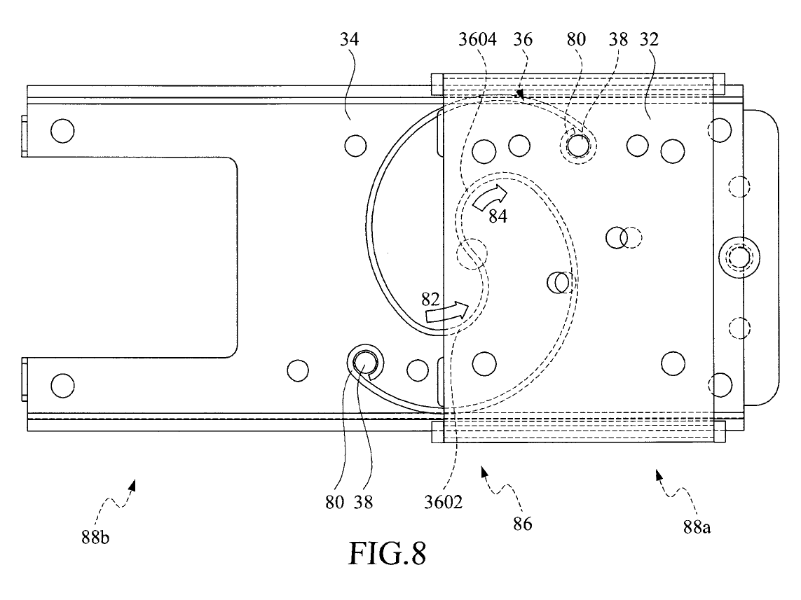

Referring to FIG. 8, it illustrates a perspective view of the slide structure 30 of FIG. 4 which is moved to the second position 88b according to the present invention. Comparing with the FIG. 7, the first slide component 32 is moved over the first position 86 so that both the first spring portion 3602 and the second spring portion 3604 will be extended and deformed by resilient force. Thus, the first slide component 32 is moved to the second position 88b with respect to the second slide component 34.

To the contrary, if the first slide component 32 is pulled back to the first position 86 with respect to the second slide component 34, then resilient force is restored. Then, the first slide component 32 is pulled away from the first position 86 so that both the first slide component 32 and the second slide component 34 will be moved back to the second position 88a by resilient force. The second positions 88a and 88b are respectively two ends of the slide stroke in which the first slide component 32 is moved with respect to the second slide component 34.

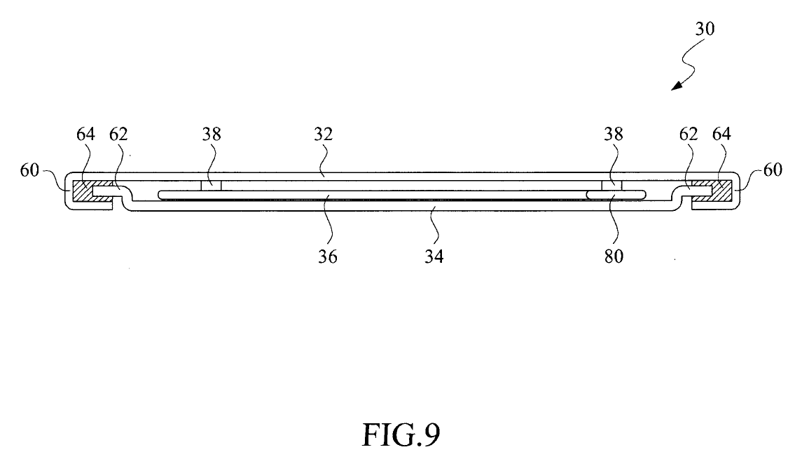

Referring to FIG. 9, it illustrates a cross-section view of the slide structure 30 according to the present invention. A clearance 90 is defined between the first slide component 32 and the second slide component 34, and the linear spring 36 is received within the clearance 90.

A guide groove 60 is formed at each of two opposite edges of the first slide component 32, and a slide fringe 62 corresponds to and is received at the guide grooves 60. Thus, the first slide component 32 is moved with respect to the second slide component 34.

The first slide component 32 and the second slide component 34 are metallic and manufactured by punch process. Each of the guide grooves 60 also includes a plastic guide rail 64, and each of the slide fringes 62 is moved within along the guide rail 64. In the light of this, the slide structure 30 is much more stable, precise, and durable.

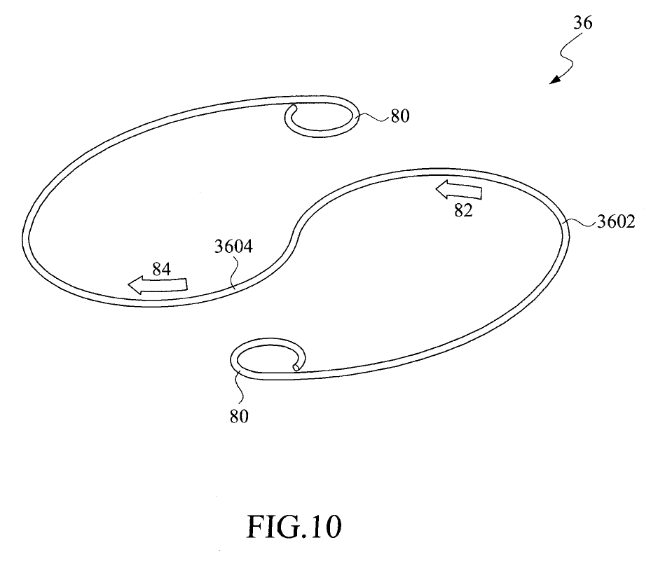

According to the linear spring 36, there are several embodiments in the present invention. Referring to FIG. 10, it illustrates a perspective view of a second embodiment of the linear spring 36 according to the present invention. Similar to FIG. 6, the first spring portion 3602 and the second spring portion 3604 are arc-shaped. However, difference between FIG. 6 and FIG. 10 is that FIG. 6 illustrates a more symmetrical symbol for Taiji and FIG. 10 illustrates the linear spring 36 with two extended S-shaped ends. According to the present invention, the slide structure 30 with the second embodiment of the linear spring 36 has longer slide stroke. The linear springs as shown in FIGS. 6 and 10 have different resilient force and manipulation, and need to be adjusted for practical uses.

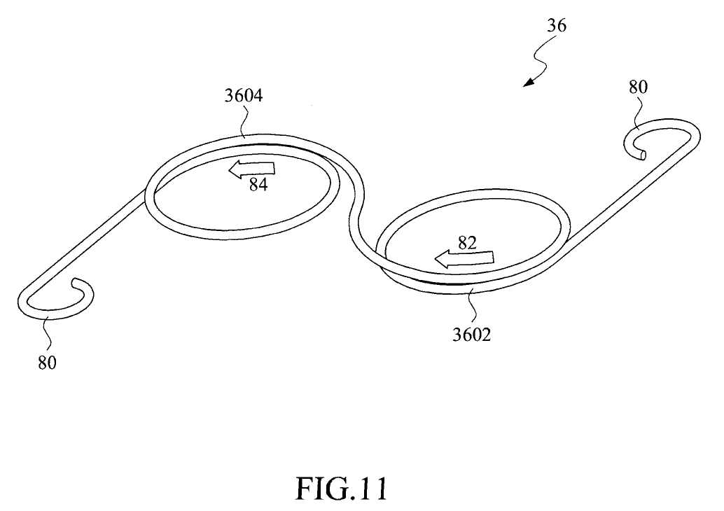

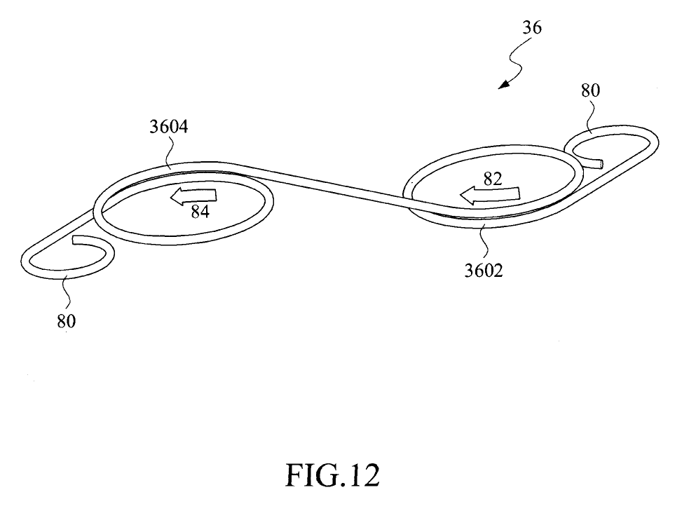

Referring to FIGS. 11, and 12, FIG. 11 illustrates a perspective view of a third embodiment of the linear spring 36 according to the present invention. FIG. 12 illustrates a perspective view of a fourth embodiment of the linear spring 36 according to the present invention. According to the present invention, the first spring portion 3602 and the second spring portion 3604 can be arc-shaped or circular. If the first spring portion 3602 and the second spring portion 3604 are circular, the linear spring 36 has a larger resilient force and is durable. Before the linear spring 36 of the slid structure 30 is shipped to market, the linear spring 36 is subjected to one hundred thousand times tests.

FIG. 11 illustrates middle portion of the linear spring 36 which is positioned between the first spring portion 3602 and the second spring portion 3604 is arc-shaped so resilience is better and manipulation is smoother. FIG. 12 illustrates middle portion of the linear spring 36 which is positioned between the first spring portion 3602 and the second spring portion 3604 is a straight line so rigidity is higher and manipulation is sturdy.

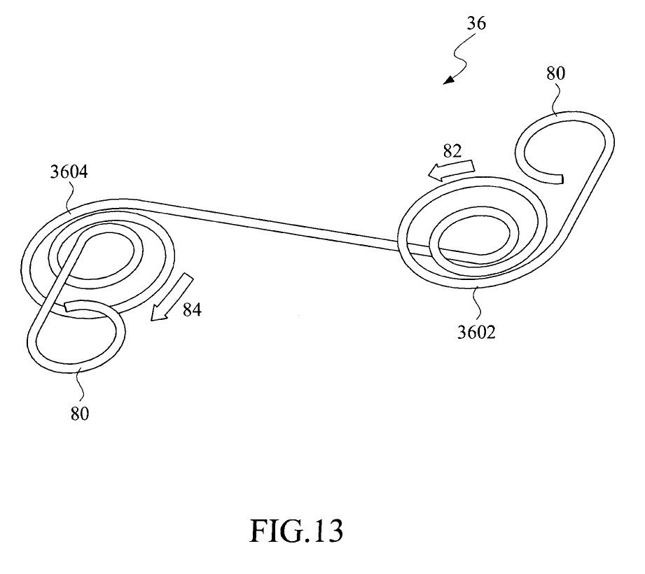

FIG. 13 illustrates a perspective view of a fifth embodiment of a linear spring 36 which is implemented in the slide structure 30 according to the present invention. The first spring portion 3602 and the second spring portion 3604 are circular and have a plurality of layers so the linear spring 36 is durable.

Furthermore, the slide structure 30 of the present invention also includes two linear springs 36 within the clearance 90 which is defined between the first slide component 32 and the second slide component 34. Therefore, the first slide component 32 is moved with respect to the second slide component 34 in a smoother way, and life expectancy of the linear spring 36 is longer.

Therefore, the slide structure 30 of the present invention is implemented in electronic devices such as mobile phones 20. The upper housing 22 is moved with respect to the lower housing 24 because of linear spring 36. In the light of this, manipulation is good and resilience and slide stroke are ideal. Besides, the linear spring 36 of the present invention is durable.

While the present invention has been particularly shown and described with reference to a preferred embodiment, it will be understood by those skilled in the art that various changes in form and detail may be without departing from the spirit and scope of the present invention.

I claim:

1. A slide structure, comprising:
a first slide component;
a second slide component, moveably connected with the first slide component so that the second slide component is moved with respect to the first slide component; and
a linear spring, including two ends, and one end fixed to the first slide component and the other end fixed to the second slide component, and the linear spring extending from one of the ends along a first turning direction so that a first spring portion is formed and then the linear spring extending from the first spring portion along a second turning direction to the other end so that a second spring portion is formed, and the first turning direction opposite to the second turning direction;
wherein when the first slide component is moved to a first position with respect to the second slide component, both the first spring portion and the second spring portion are compressed and deformed so as to establish a resilient force, and both the first spring portion and the second spring portion will be extended and deformed by the resilient force so that the first slide component is moved to a second position with respect to the second slide component.

2. The slide structure according to claim 1, wherein a guide groove is formed at each of two opposite edges of the first slide component, and a slide fringe corresponds to and is received at each of the guide grooves so that the first slide component is moved with respect to the second slide component.

3. The slide structure according to claim 2, wherein the first slide component and the second slide component are metallic and manufactured by punch process, and each of the guide grooves further includes a plastic guide rail, and each of the slide fringes is moved within along the guide rail.

4. The slide structure according to claim 1, wherein the first slide component and the second slide component have rivets respectively, and the two ends of the linear spring are respectively interwined at two rivets so that two ends are respectively fixed to the first slide component and the second slide component.

5. The slide structure according to claim 1, wherein the first position is the midpoint of the slide stroke in which the first slide component is moved with respect to the second slide component, and both ends of the slide stroke are the second positions.

6. The slide structure according to claim 1, wherein the linear spring is positioned within a clearance which is defined between the first slide component and the second slide component.

7. The slide structure according to claim 1, wherein the slide structure has two linear springs.

8. The slide structure according to claim 1, wherein the first spring portion and the second spring portion are arc-shaped respectively.

9. The slide structure according to claim 1, wherein the first spring portion and the second spring portion are circular respectively.

10. The slide structure according to claim 1, wherein the first spring portion and the second spring portion are circular and have a plurality of circles respectively.
